(19) United States
(12) Patent Application Publication
(10) Pub. No.: US 2020/0047447 A1
(43) Pub. Date: Feb. 13, 2020

(54) DISCHARGE CONVEYOR SYSTEM FOR CUT CUSHIONING MATERIAL

(71) Applicant: Sealed Air Corporation (US), Charlotte, NC (US)

(72) Inventors: Joseph Beauregard, Dracut, MA (US); Gary Wood, Pelham, NH (US); Andreas Gabrielsen, Otisville, NY (US); Kostadin Kostadinov, Billerica, MA (US)

(21) Appl. No.: 16/344,843

(22) PCT Filed: Oct. 24, 2017
(86) PCT No.: PCT/US2017/058028

§ 371 Date: Apr. 25, 2019

Related U.S. Application Data
(60) Provisional application No. 62/413,098, filed on Oct. 26, 2016.

(51) Int. Cl. B31D 5/00; B65G 15/20

(52) U.S. Cl. CPC B31D 5/0073; B65G 15/20

(57) ABSTRACT

A system (400) for cutting and conveying cushioning material includes an infeed conveyor system (402), a cutting mechanism (404), and a discharge conveyor system (406). The infeed conveyor system conveys a supply of cushioning material. The cutting mechanism cuts pieces of the cushioning material from the supply of cushioning material conveyed by the infeed conveyor system. The discharge conveyor system captures and discharges the pieces of the cushioning material. The discharge conveyor system includes a first conveyor (428) in a fixed planar position and a second conveyor (430) that rotates about an upstream roller (440) of the second conveyor. A downstream roller (442) of the second conveyor is biased toward first conveyor. A driving mechanism rotates at least one conveyor belt (438) on one or more of the first conveyor or the second conveyor.

### BACKGROUND

The present disclosure is in the technical field of conveying cushioning material. More particularly, the present disclosure is directed to discharge conveyor systems that capture and convey pieces of cushioning material after the pieces have been cut from a supply of the cushioning material.

When articles are packaged in a container or box for shipping, there are frequently void spaces in the container. Protective cushioning material for articles of different sizes and shapes is commonly used to cushion articles during shipping. There are numerous types and forms of cushioning material for this purpose including waste paper, embossed paper, laminated bubble paper, plastic beads, pre-inflated bubble film, inflatable bubble film, foam pads, and the like. These forms of cushioning material are capable of being placed around articles to protect the articles during shipment and to fill the void space in the container. While these cushioning materials are effective in protecting articles during shipment, they can be time-consuming to properly handle and use in a packaging facility for efficient packaging.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a conveyor system includes a first conveyor, a second conveyor, and a driving mechanism. The first conveyor has a first upstream roller, a first downstream roller, and a first conveyor belt configured to be supported by the first upstream roller and the first downstream roller. The second conveyor has a second upstream roller, a second downstream roller, and a second conveyor belt configured to be supported by the second upstream roller and the second downstream roller. The driving mechanism is configured to rotate at least one of the first upstream roller, the first downstream roller, the second upstream roller, or the second downstream roller. Positions of the first upstream roller, the first downstream roller, and the second upstream roller are fixed with respect to each other. The second downstream roller is configured to rotate with respect to the second upstream roller and the second downstream roller is biased toward the first conveyor.

In one example, the system further includes a hard stop configured to prevent the second conveyor from being rotated away from the first conveyor beyond a position that is substantially parallel to the first conveyor. In another example, the system further includes a hard stop configured to prevent the second conveyor from being rotated toward the first conveyor beyond a particular position. In another example, the damper is configured to resist rotational movement of the second conveyor as the second conveyor rotates toward the hard stop. In another example, a spring force of the damper is less than a force of the second conveyor exerted as a result of the second downstream roller being biased toward the first conveyor.

In another example, the second conveyor is located above the first conveyor. In another example, the second downstream roller is biased toward the first conveyor by gravity. In another example, the second downstream roller is biased toward the first conveyor by a biasing mechanism. In another example, at least one of the first and second conveyor belts includes a plurality of individual belt portions. In another example, at least one of the first and second conveyor belts includes at least one of an elastic material, an elastomeric material, or an anti-static material. In another example, the conveyor system is located downstream of a cutting mechanism configured to cut cushioning material into pieces, and wherein the first and second conveyors are configured to capture the pieces of the cushioning material cut by the cutting system. In another example, the driving mechanism is configured to rotate the first upstream roller and the second upstream roller in opposite rotational directions. In another example, the driving mechanism is coupled to the first and second upstream rollers via a timing belt. In another example, the timing belt is configured to engage a first gear fixedly coupled to the first upstream roller, a second gear fixedly coupled to the second upstream roller, and a third gear arranged to be driven by the driving mechanism.

In another embodiment, a system is usable for for cutting and conveying cushioning material. The system includes an infeed conveyor system configured to convey a supply of cushioning material, a cutting mechanism configured to cut pieces of the cushioning material from the supply of cushioning material conveyed by the infeed conveyor system, and a discharge conveyor system configured to capture the pieces of the cushioning material cut by the cutting mechanism and to discharge the pieces of the cushioning material. The discharge conveyor system includes a first conveyor in a fixed planar position, a second conveyor configured to rotate about an upstream roller of the second conveyor, and a driving mechanism configured to rotate at least one conveyor belt on one or more of the first conveyor or the second conveyor. A downstream roller of the second conveyor is biased toward the first conveyor.

In one example, the infeed conveyor system includes a third conveyor and a fourth conveyor, where the third conveyor is in a first fixed planar position that is co-planar with the first conveyor. In another example, the fourth conveyor is in a second fixed planar position that is substantially parallel to the third conveyor and is aligned with the upstream roller of the second conveyor. In another example, the cutting mechanism is located between the infeed conveyor system and the discharge conveyor system. In another example, the cushioning material includes one or more of pre-inflated bubble film inflated before arriving at a location of the system, bubble film inflated at the location of the system, or foam cushioning. In another example, the driving mechanism is configured to rotate the at least one conveyor belt at a rate that is equal to or greater than a rate at which a conveyor belt of the infeed conveyor system is rotated.

### BRIEF DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIGS. 1A and 1B depict examples of packaging facilities, in accordance with the embodiments described herein;

FIGS. 2A and 2B depict examples of interior views of an embodiment of a feed and cut system, in accordance with the embodiments described herein;

FIGS. 3A and 3B depict an embodiment of a feed and cut system that includes a discharge conveyor system and examples of different cushioning materials being fed through the feed and cut system, in accordance with the embodiments described herein;

FIG. 4A depicts a feed and cut system with a discharge conveyor system that is capable of effectively discharging pieces of cushioning material of a variety of sizes, in accordance with the embodiments described herein;

FIGS. 4B to 4D depict various types of cushioning material being fed by the feed and cut system depicted in FIG. 4A, in accordance with the embodiments described herein; and

FIGS. 5A and 5B depict perspective and side views, respectively, of another embodiment of a discharge conveyor system, in accordance with the embodiments described herein.

### DETAILED DESCRIPTION

The present disclosure describes embodiments of conveying cushioning material. More particularly, the present disclosure is directed to discharge conveyor systems that capture and convey pieces of cushioning material after the pieces have been cut from a supply of the cushioning material.

Embodiments of discharge conveyor systems described herein include a first conveyor in a fixed planar position and a second conveyor that is capable of rotating about an upstream roller that is in a fixed position with respect to the first conveyor. A downstream roller of the second conveyor is biased toward the first conveyor. The discharge conveyor systems include a driving mechanism that rotates a conveyor belt on the first conveyor and/or a conveyor belt on the second conveyor. This arrangement leaves a discharge conveyor system biased to a wedge shape to that effectively accommodates thinner cushioning materials and is capable of automatically adjusting to accommodate thicker cushioning materials. This allows the discharge conveyor system to be used with a range of cushion material sizes.

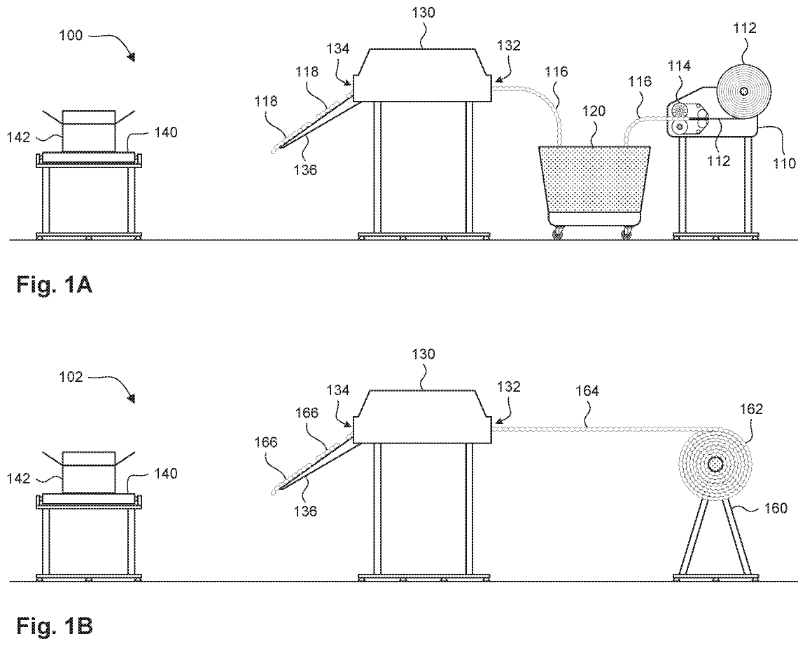

An example of a packaging facility 100 is depicted in FIG. 1A. The packaging facility 100 includes a cushion supply system 110, a storage container 120, a feed and cut system 130, and a package conveyor system 140. In the depicted embodiment, the cushion supply system 110 holds a supply roll of uninflated film 112. The cushion supply system 110 also includes an inflation and sealing system 114. The inflation and sealing system 114 is configured to pull the uninflated film 112 off of the supply roll, to inflate the uninflated film 112 to form an inflated film 116. Examples of Inflatable film and inflation and sealing systems are described in U.S. Pat. No. 8,978,345, the contents of which are hereby incorporated by reference in their entirety. While the particular embodiment shown in FIG. 1A depicts that the cushion supply system 110 supplies inflatable film that s inflated at a location of the feed and cut system 130, the cushion supply system 110 may provide any type of cushioning material. In one example, the cushioning material provided is pre-inflated bubble film that is inflated before arrival at the location of the feed and cut system 130, such as BUBBLE WRAP pre-inflated bubble film distributed by Sealed Air Corporation.

In the depicted embodiment, the inflated film 116 is fed from the cushion supply system 110 into the storage container 120. In the depicted embodiment, the storage container 120 is a wheeled cart. In other embodiments, the storage container 120 can be any type of container, such as a box, a carton, a bag, or any other container. The inflated film is then provided from the storage container 120 to the feed and cut system 130. The storage container 120 is capable of holding excess amounts of the inflated film 116 produced by the cushion supply system 110 that are not yet used by the feed and cut system 130. This allows the cushion supply system 110 to produce the inflated film 116 at times when the feed and cut system 130 is not pulling in the inflated film 116 and it permits the feed and cut system 130 to pull the inflated film 116 temporarily at rates that exceed the rate at which the cushion supply system 110 produced the inflated film 116.

The feed and cut system 130 includes an inlet 132 that receives inflated film 116 from the storage container 120 and an outlet 134 that discharges inflated film pieces 118 that are cut from the inflated film 116. The interior of the feed and cut system 130 includes a feed system, such as a conveyor belt, that pulls the inflated film 116 into the inlet 132. The interior of the feed and cut system 130 also includes a cutting mechanism, such as a blade, a heated wire, or any other cutting device, that cuts the inflated film 116 into the inflated film pieces 118. The inflated film pieces 118 are then discharged through the outlet 134. In the depicted embodiment, the inflated film pieces 118 are discharged through the outlet 134 onto a chute 136 of the feed and cut system 130.

The package conveyor system 140 facilitates movement of a shipping container 142, such as a box, a mailer, a pallet, and the like. An article (or more than one article) may be packaged in the shipping container 142 for shipment (e.g., to a purchaser of the article). The article may be protected within the shipping container 142 using the inflated film pieces 118. In some cases, a packager may take the inflated film pieces 118 from the chute 136 and place the inflated film pieces 118 inside of the shipping container 142 to protect the article. As shown in FIG. 1A, the feed and cut system 130 is capable of cutting the inflated film pieces 118 at a number of different lengths. In some embodiments, the feed and cut system 130 is configured to produce inflated film pieces 118 of particular lengths based on a size of the article or a user input.

Depicted in FIG. 1B is a packaging facility 102 that is a variation of the packaging facility 100 depicted in FIG. 1A. The packaging facility 102 includes the feed and cut system 130 and the package conveyor system 140 depicted in FIG. 1A. The packaging facility 102 also includes a cushion supply system 160. The cushion supply system 160 holds a supply material roll 162, such as a roll of pre-inflated bubble film (e.g., bubble film that was inflated before it arrived at the location of the feed and cut system 130). Because the supply material roll 162 includes cushioning material that does not need any further processing before being fed into the feed and cut system 130, the packaging facility 102 does not include the storage container 120 that is included in the packaging facility 100.

The feed and cut system 130 is configured to pull cushioning material 164 from the supply material roll 162. The feed and cut system 130 feeds the cushioning material 164 in through the inlet 132 and cuts the cushioning material 164 into cushioning material pieces 166. The cushioning material pieces 166 are discharged through the outlet 134 onto the chute 136. A packager is able to remove the cushioning material pieces 166 from the chute 136 and use them to protect an article in the shipping container 142.

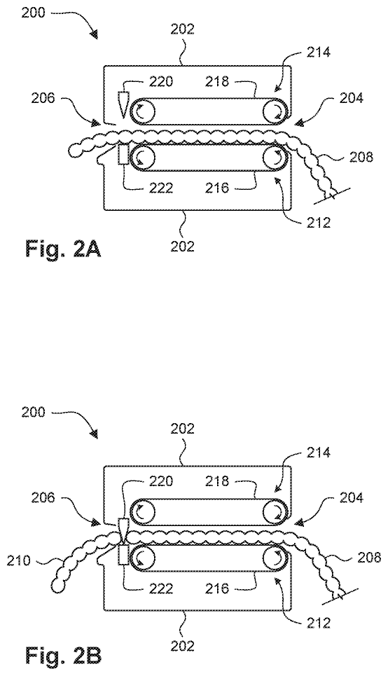

Depicted in FIGS. 2A and 2B are interior views of an embodiment of a feed and cut system 200. The feed and cut system 200 includes a housing 202 that is formed from a rigid material, such as metal or rigid plastic. The housing 202 includes an inlet 204 and an outlet 206. The inlet 204 is arranged to receive a supply of cushioning material 208 and the outlet 206 is arranged to discharge pieces 210 of the cushioning material 208. The feed and cut system 200 includes a first conveyor 212 and a second conveyor 214. The first conveyor 212 includes a conveyor belt 216 and the second conveyor 214 includes a conveyor belt 218. The first and second conveyors 212 and 214 feed the cushioning material 208 through the housing 202.

The feed and cut system 200 also includes a cutting mechanism 220 and a cutting surface 222. The cutting mechanism 220 depicted in FIGS. 2A and 2B is a blade, but the cutting mechanism 220 may be any device that is capable of cutting the cushioning material 208. As shown in FIG. 2B, the cutting mechanism 220 is capable of cutting the cushioning material 208 to form the pieces 210 of the cushioning material 208. The pieces 210 are discharged from the housing 202 through the outlet 206.

Once the pieces 210 are cut by the cutting mechanism 220, the pieces 210 are no longer controlled by the feed and cut system 200. In the depiction shown in FIG. 2B, the piece 210 of the cushioning material 208 that has been cut is not in contact with the first and second conveyor belts 216 and 218 and the piece is able to fall from the outlet 206. This lack of control of the pieces 210 cut from the cushioning material 208 may cause the pieces 210 to be discharged improperly (e.g., in an improper location, in an improper order, etc.). This is especially problematic in cases where the feed and cut system 200 is cutting the cushioning material 208 to specific lengths to fit particular articles and/or shipping containers. Additionally, while the arrangement of the cutting mechanism 220 in close proximity to the outlet 206 may allow for the pieces 210 to fall out of the outlet 206, the proximity of the cutting mechanism 220 to the outlet 206 may not permit safe operation of the feed and cut system 200. For example, users of the feed and cut system 200 will frequently be grabbing the pieces 210 cut from the cushioning material 208 and may inadvertently be harmed by the cutting mechanism 220 if they reach inside the outlet 206 when grabbing one of the pieces 210.

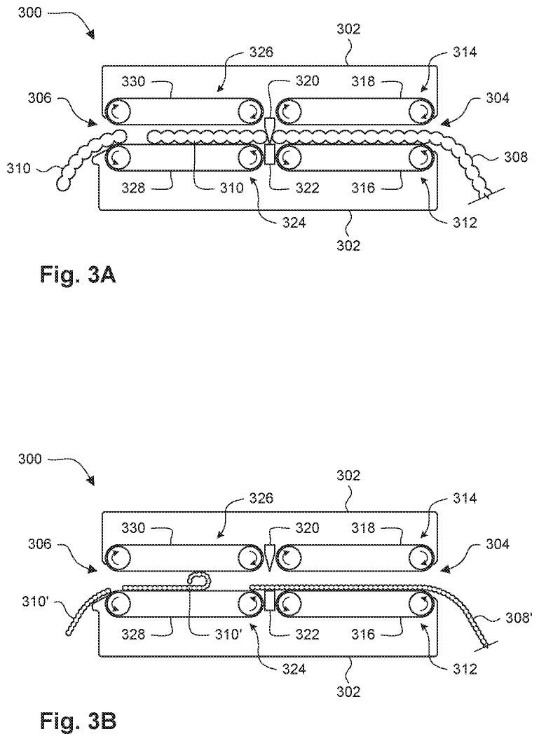

Depicted in FIG. 3A is an embodiment of a feed and cut system 300 that has a discharge conveyor system. The feed and cut system 300 includes a housing 302 that is formed from a rigid material, such as metal or rigid plastic. The housing 302 includes an inlet 304 and an outlet 306. The inlet 304 is arranged to receive a supply of cushioning material 308 and the outlet 306 is arranged to discharge pieces 310 of the cushioning material 308. The feed and cut system 300 includes a first conveyor 312 and a second conveyor 314. The first conveyor 312 includes a conveyor belt 316 and the second conveyor 314 includes a conveyor belt 318. The first and second conveyors 312 and 314 feed the cushioning material 308 through the housing 302.

The feed and cut system 300 also includes a cutting mechanism 320 and a cutting surface 322. The cutting mechanism 320 depicted in FIG. 3A is a blade, but the cutting mechanism 320 may be any device that is capable of cutting the cushioning material 308. As shown in FIG. 3A, the cutting mechanism 320 is capable of cutting the cushioning material 308 to form the pieces 310 of the cushioning material 308. The pieces 310 are then conveyed by a third conveyor 324 and a fourth conveyor 326 to the outlet 306. The pieces 310 are then discharged from the housing 302 through the outlet 306. The third conveyor 324 includes a conveyor belt 328 and the fourth conveyor 326 includes a conveyor belt 330.

In the depicted embodiment, the first conveyor 312 is in a fixed planar position. The second conveyor 314 is also in a fixed planar position that is substantially parallel to the first conveyor 312. The third conveyor 324 is also in a fixed planar position. The fixed planar position of the third conveyor 324 is substantially aligned with the fixed planar position of the first conveyor 312. The fourth conveyor 326 is also in a fixed planar position that is substantially parallel to the third conveyor 324. The fixed planar position of the third conveyor 324 is substantially aligned with the fixed planar position of the second conveyor 314. This arrangement of the first, second, third, and fourth conveyors 312, 314, 324, and 326 allows the cushioning material 308 to be conveyed between the first and second conveyors 312 and 314 and between the third and fourth conveyors 324 and 326.

As shown in FIG. 3A, the arrangement of the first and second conveyors 312 and 314 is capable of effectively feeding the cushioning material 308 from the inlet 304 to the cutting mechanism 320 and the arrangement of the third and fourth conveyors 324 and 326 is capable of effectively feeding the pieces 310 of the cushioning material 308 to the outlet 306. However, the feed and cut system 300 may not be effective for a range of cushioning material sizes.

Depicted in FIG. 3B is an stance of the feed and cut system 300 as it conveys a cushioning material 308′ and pieces 310′ of the cushioning material 308′. The cushioning material 308′ has a smaller thickness than the cushioning material 308. As shown, the arrangement of the first and second conveyors 312 and 314 may be capable of effectively feeding the cushioning material 308′ from the inlet 304 to the cutting mechanism 320. However, the arrangement of the third and fourth conveyors 324 and 326 may not be capable of effectively feeding the pieces 310′ of the cushioning material 308 to the outlet 306. In particular, one of the pieces 310′ has curled upward and contacted the fourth conveyor 326. Such a position may cause the pieces 310′ to jam the feed and cut system 300, which may cause delays on packaging lines with the lack of cushioning material pieces be provided by the feed and cut system 300 and the time required to repair the feed and cut system 300.

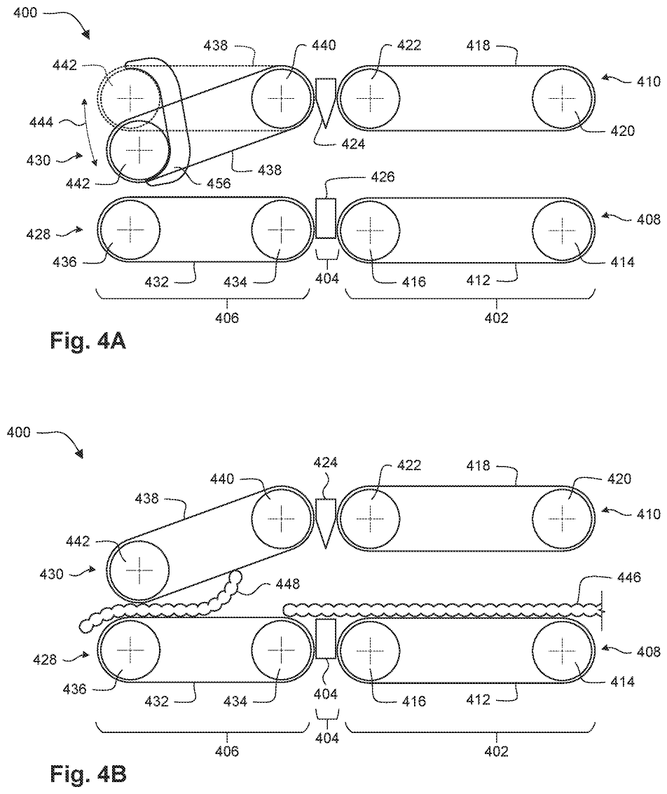

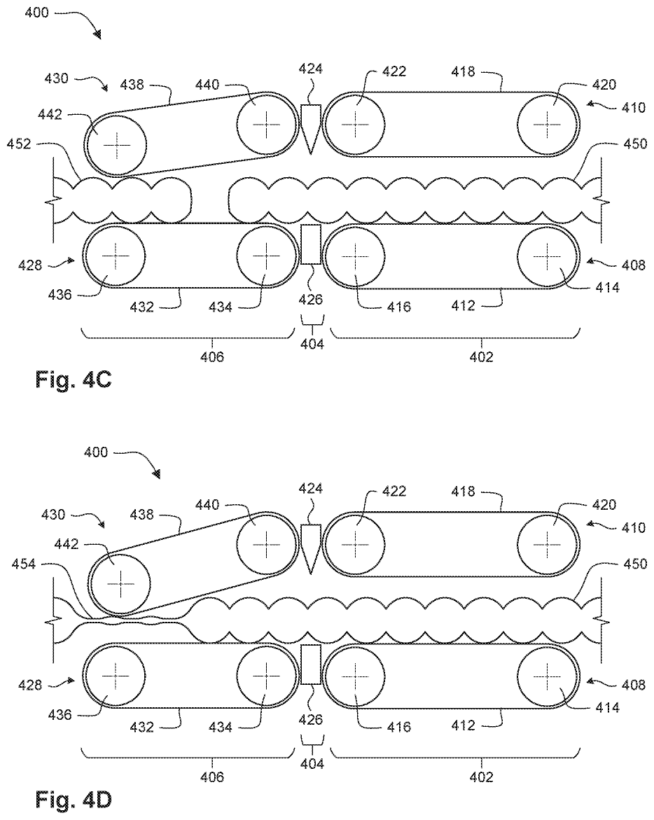

Depicted in FIG. 4A is a feed and cut system 400 with a discharge conveyor system that is capable of effectively discharging pieces of cushioning material of a variety of sizes. The feed and cut system 400 includes an infeed conveyor system 402, a cutting mechanism 404, and a discharge conveyor system 406. The infeed conveyor system 402 includes a first conveyor 408 and a second conveyor 410. The first conveyor 408 includes a conveyor belt 412 that spans between an upstream roller 414 and a downstream roller 416. The second conveyor 410 includes a conveyor belt 418 that spans between an upstream roller 420 and a downstream roller 422. The feed and cut system 400 may include a driving mechanism (not shown) that rotates one or both of the conveyor belts 412 and 418. In one example, the driving mechanism (e.g., an electric motor, a solenoid, an internal combustion engine, etc.) is configured to rotate one or more of the upstream rollers 414 and 420 and the downstream rollers 416 and 422 in order to cause rotation of one or both of the conveyor belts 412 and 418. In the depicted embodiment, the first conveyor 408 is in a fixed planar position. The second conveyor 410 is also in a fixed planar position that is substantially parallel to the first conveyor 408.

The cutting mechanism 404 that is capable of cutting cushioning material that passes through the feed and cut system 400. In the depicted embodiment, the cutting mechanism 404 includes a blade 424 and a cutting surface 426. The blade 424 can be forced into the cutting surface 426 in order to cut any cushioning material between the blade 424 and the cutting surface 426. Some examples of cushioning material include waste paper, embossed paper, laminated bubble paper, plastic beads, pre-inflated bubble film, inflatable bubble film, foam pads, and the like. In other embodiments, the cutting mechanism 404 includes a heated wire, such as in the case of pre-inflated bubble film or inflatable bubble film cushioning materials. In other embodiments, the cutting mechanism 404 includes any other cutting device that is capable of cutting cushioning material. In some embodiments, the cutting mechanism 404 is configured to make a transverse cut across a width of a cushioning material fed through the feed and cut system 400. In some embodiments, the cutting mechanism 404 is configured to adjust the amount of time between making cuts in cushion material to adjust the length of the pieces of the cushioning material cut by the cutting mechanism 404.

The discharge conveyor system 406 includes a first conveyor 428 and a second conveyor 430. The first conveyor 428 includes a conveyor belt 432 that spans between an upstream roller 434 and a downstream roller 436. The second conveyor 430 includes a conveyor belt 438 that spans between an upstream roller 440 and a downstream roller 442. The feed and cut system 400 may include a driving mechanism (not shown) that rotates one or both of the conveyor belts 432 and 438. In one example, the driving mechanism (e.g., an electric motor, a solenoid, an internal combustion engine, etc.) is configured to rotate one or more of the upstream rollers 434 and 440 and the downstream rollers 436 and 442 in order to cause rotation of one or both of the conveyor belts 432 and 438.

In the depicted embodiment, the first conveyor 428 is in a fixed planar position. The fixed planar position of the first conveyor 428 is substantially aligned with the fixed planar position of the first conveyor 408 of the infeed conveyor system 402 (i.e., the first conveyor 428 is co-planar with the first conveyor 408 of the infeed conveyor system 402). The upstream roller 440 of the second conveyor 430 is in a fixed position with respect to the upstream roller 434 and the downstream roller 436 of the first conveyor 428. The downstream roller 442 of the second conveyor 430 is configured to rotate about the upstream roller 440 of the second conveyor 430 in the rotational direction 444 depicted in FIG. 4A. In the depicted embodiment, the fixed planar position of the second conveyor 410 of the infeed conveyor system 402 is aligned with the upstream roller 440 of the second conveyor 430 of the discharge conveyor system 406.

In some embodiments, the second conveyor 430 is biased toward the first conveyor 428. For example, the second conveyor may be biased by gravity, by a biasing mechanism (e.g., a spring, an actuator, etc.), by a magnetic force, or by any other means. In the embodiment depicted in FIG. 4A, the second conveyor 430 is biased toward the position of the second conveyor 430 shown in solid lines and the second conveyor 430 is capable of being rotated away from the first conveyor 428 to the position shown in dashed lines In some embodiments, the feed and cut system 400 includes a hard stop 456 that prevents either or both of rotational movement of the second conveyor 430 toward the first conveyor 428 beyond the particular position shown in solid lines in FIG. 4A and/or rotational movement of the second conveyor 430 away the first conveyor 428 beyond the particular position shown in dashed lines in FIG. 4A (e.g., beyond a position that is substantially parallel to the first conveyor 428).

The effect of the rotatable second conveyor 430 in the discharge conveyor system 406 is that the discharge conveyor system 406 is biased to a wedge shape to that effectively accommodates thinner cushioning materials while being capable of adjusting to accommodate thicker cushioning materials. This allows the feed and cut system 400 to be used with a range of cushion material sizes. Examples of these capabilities are depicted in FIGS. 4B, 4C, and 4D.

In FIG. 4B, a cushion material 446 is fed into the feed and cut system 400 by the infeed conveyor system 402. The cutting mechanism 404 has cut a piece 448 from the cushioning material 446. The discharge conveyor system 406 has captured the piece 448 and is feeding the piece 448 through the discharge conveyor system 406. As shown, the piece 448 has curled until the end on the far right, as shown in FIG. 4B, has contacted the conveyor belt 438 of the second conveyor 430. Because of the downward angle of the second conveyor 430, the discharge conveyor system 406 does not allow the piece 448 to fully curl over and continues feeding the piece 448 out of the discharge conveyor system 406 without jamming the feed and cut system 400. In the embodiment shown in FIG. 4B, the downstream roller 442 is at the location closest to the first conveyor 428 permitted in a range of the rotational direction 444. This position of the downstream roller 442 to effectively accommodate the relatively small thickness of the cushioning material 446. In one example, the thickness of the cushioning material 446 is approximately 0.25 inches.

In FIG. 4C, a cushion material 450 is fed into the feed and cut system 400 by the infeed conveyor system 402. The cutting mechanism 404 has cut a piece 448 from the cushioning material 446. The discharge conveyor system 406 has captured the piece 452 and is feeding the piece 452 through the discharge conveyor system 406. The thickness of the cushioning material 450 is greater than the thickness of the cushioning material 446. As the piece 452 of the cushioning material 450 passes through the discharge conveyor system 406, the thickness of the piece 452 causes the downstream roller 442 to rotate upwardly away from the first conveyor 428. This ability of the downstream roller 442 and the second conveyor 430 to rotate upward allows the discharge conveyor system 406 to accommodate the greater thickness of the piece 452 of the cushioning material 450. In one example, the thickness of the cushioning material 446 is approximately 1.2 inches.

Depicted in FIG. 4D is an example of how the feed and cut system 400 is able to adjust to facilitate defects in the cushioning material 450. In some instances, particularly in the case of inflatable bubble film that is inflated at the location of the feed and cut system 400, particular rows of bubbles in the film may not be inflated properly (e.g., partially inflated, not inflated, not sealed, etc.). In FIG. 4D, the cushion material 450 includes improperly inflated rows 454. As shown in FIG. 4D, the second conveyor automatically rotates downward so the conveyor belt 438 remains in contact with the cushion material 450 at the improperly inflated rows 454. This continued contact with the cushion material 450 at the improperly inflated rows 454 allows the discharge conveyor system 406 to continue conveying the cushion material 450, or any piece thereof, even if there are defects in the cushion material 450.

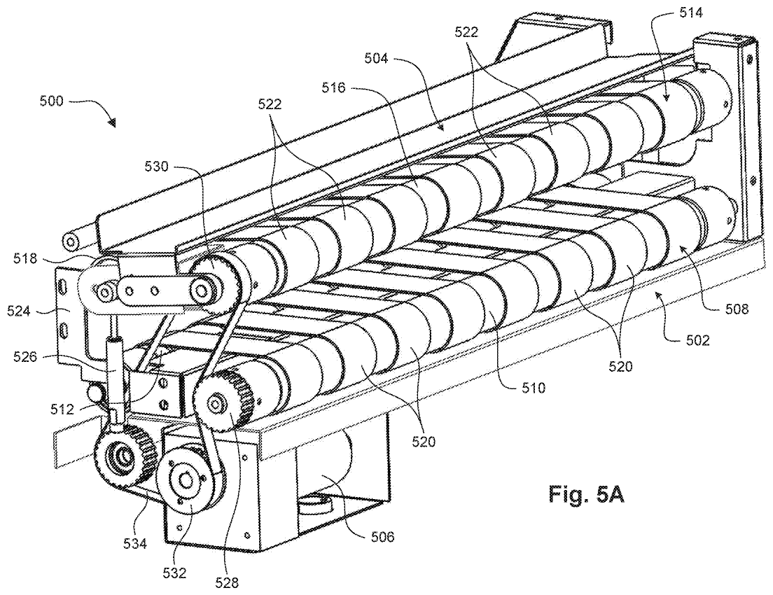

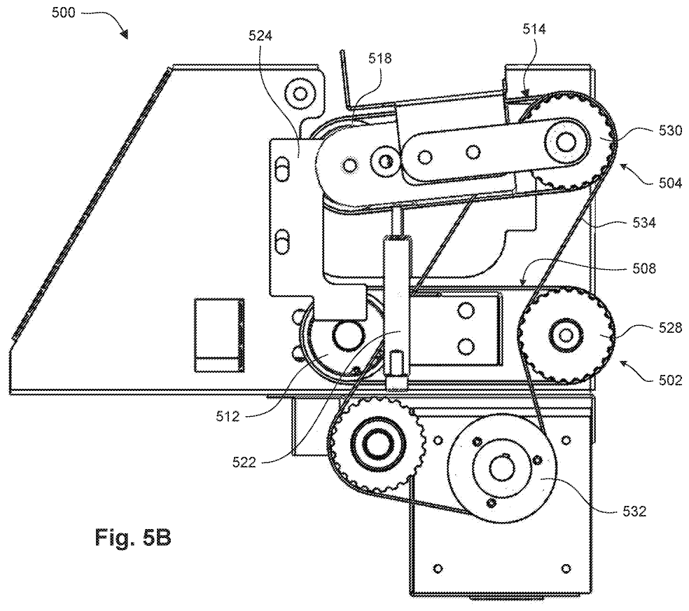

Another embodiment of a discharge conveyor system 500 is depicted in the perspective and side views shown, respectively, in FIGS. 5A and 5B. The discharge conveyor system 500 includes a first conveyor 502, a second conveyor 504, and a driving mechanism 506. The first conveyor 502 includes a conveyor belt 508 that spans between an upstream roller 510 and a downstream roller 512. The second conveyor 504 includes a conveyor belt 514 that spans between an upstream roller 516 and a downstream roller 518. The positions of the upstream roller 510, the downstream roller 512, and the upstream roller 516 are fixed with respect to each other. The downstream roller 518 is configured to rotate with respect to the upstream roller 516. The downstream roller 518 is biased toward the first conveyor 502. In the particular embodiment depicted in FIGS. 5A and 5B, the downstream roller 518 is biased toward the first conveyor 502 by gravity.

In the depicted embodiment, the conveyor belt 508 includes a number of individual belt portions 520 and the conveyor belt 514 includes a number of individual belt portions 522. Having a number of individual belt portions 520 and 522 allows the conveyor belts 508 and 514 to captures pieces of cushioning material while minimizing any damage to the pieces of cushioning material. In some embodiments, the conveyor belts 508 and 514 are made from one or more of an elastic material, an elastomeric material, or an anti-static material. In some examples, elastic and elastomeric materials may aid in minimizing any damage to the pieces of cushioning material. In other examples, anti-static materials may prevent some pieces of cushioning material (e.g., pre-inflated bubble film, laminated bubble film, etc.) from clinging to one or both of the conveyor belts 508 and 514 as the pieces are discharged from the discharge conveyor system 500.

The discharge conveyor system 500 includes a hard stop 524. The hard stop 524 is configured to prevent the second conveyor 504 from being rotated away from the first conveyor 502 beyond a particular position. In the depicted embodiment, the hard stop 524 prevents the second conveyor 504 from being rotated away from the first conveyor 502 to a position that is substantially parallel to the first conveyor 502. The hard stop 524 is also configured to prevent the second conveyor 504 from being rotated toward the first conveyor 502 beyond a particular position. In some embodiments, the hard stop 524 also prevents the second conveyor 504 from being rotated to a position at which the second conveyor 504 comes in contact with the first conveyor 502.

In the depicted embodiment, the discharge conveyor system 500 includes a damper 526 that is coupled to the second conveyor 504. The damper 526 resists rotational movement of the second conveyor 504. In some embodiments, the damper 526 resists rotational movement of the second conveyor 504 both toward and away from the first conveyor 502. In some embodiments, the damper 526 resists rotational movement of the second conveyor 504 only toward the first conveyor 502. The damper 526 may prevent the second conveyor 504 from hitting the hard stop 524 at a speed that would cause a loud noise to emanate from the discharge conveyor system 500, vibration of the discharge conveyor system 500, or any other damage to the discharge conveyor system 500. In some embodiments, the spring force of the damper 526 is less than the force of the second conveyor 504 exerted as a result of the downstream roller 518 being biased toward the first conveyor 502.

In some embodiments, the driving mechanism 506 is capable of rotating one or more of the upstream roller 510, the downstream roller 512, the upstream roller 516, or the downstream roller 518. In the depicted embodiment, the driving mechanism 506 is capable of rotating the upstream roller 510 and the upstream roller 516 in opposite rotational directions. The discharge conveyor system 500 includes a first gear 528 that is fixedly coupled to the upstream roller 510, a second gear 530 that is fixedly coupled to the upstream roller 516, and a third gear 532 that is arranged to be driven by the driving mechanism 506. A timing belt 534 is routed to engage the first, second, and third gears 528, 530, and 532. In the depicted embodiment, the timing belt is a double-sided timing belt that is routed to rotate the first gear 528 in one rotational direction (counterclockwise in the depiction in FIG. 5B) and the second gear 530 in the opposite rotational direction (clockwise in the depiction in FIG. 5B).

In the depicted embodiment, the driving mechanism 506 is a DC electric motor. In other embodiments, the driving mechanism 506 may include one or more of a DC electric motor, an AC electric motor, an internal combustion engine, a non-combustion engine, a pneumatic motor, a hydraulic motor, or any other motor. In the depicted embodiment, the driving mechanism 506 includes one motor that drive both of the upstream rollers 510 and 516. In other embodiments, the driving mechanism 506 may include more than one motor or engine, each of which drives one roller. In other embodiments, the driving mechanism 506 includes a motor that rotates one or more of the rollers in the discharge conveyor system 500 and one or more other rollers, such as a roller in an infeed conveyor system.

One or more dimensions of the discharge conveyor system 500 may be selected based on a range of criteria. In some embodiments, the widths of the upstream and downstream rollers 510, 512, 516, and 518 may selected based on a width of cushioning material to be fed through the discharge conveyor system 500. For example, widths of the upstream and downstream rollers 510, 512, 516, and 518 may selected to accommodate a cushioning material up to 30 inches wide. In some embodiments, the spacing between the upstream rollers 510 and 516 may selected to accommodate cushioning material up to a particular thickness, such as cushioning material up to 1.25 inches thick. In some embodiments, the closest the downstream roller 518 is permitted to rotate downward toward the first conveyor 502 leaves a space between the first conveyor 502 and the second conveyor 504 based on a lower thickness of cushioning material expected to be fed through the discharge conveyor system 500, such as a cushioning material thickness of 0.25 inches. In some embodiments the distance between the upstream roller 510 and the downstream roller 512 may be selected based on a minimum length of cushioning material pieces cut by a cutting mechanism. For example, if a cutting mechanism is configured to cut pieces of cushioning material at length of greater than or equal to about 6 inches, the distance between the upstream roller 510 and the downstream roller 512 may be about 5 inches.

For purposes of this disclosure, terminology such as “upper,” “lower,” “vertical,” “horizontal,” “inwardly,” “outwardly,” “inner,” “outer,” “front,” “rear,” and the like, should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Unless stated otherwise, the terms “substantially,” “approximately,” and the like are used to mean within 5% of a target value.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

What is claimed is:

1. A conveyor system comprising:
a first conveyor having a first upstream roller, a first downstream roller, and a first conveyor belt configured to be supported by the first upstream roller and the first downstream roller;
a second conveyor having a second upstream roller, a second downstream roller, and a second conveyor belt configured to be supported by the second upstream roller and the second downstream roller; and
a driving mechanism configured to rotate at least one of the first upstream roller, the first downstream roller, the second upstream roller, or the second downstream roller;
wherein positions of the first upstream roller, the first downstream roller, and the second upstream roller are fixed with respect to each other; and
wherein the second downstream roller is configured to rotate with respect to the second upstream roller and the second downstream roller is biased toward the first conveyor.

2. The conveyor system of claim 1, further comprising:
a hard stop configured to prevent the second conveyor from being rotated away from the first conveyor beyond a position that is substantially parallel to the first conveyor.

3. The conveyor system of claim 1, further comprising:
a hard stop configured to prevent the second conveyor from being rotated toward the first conveyor beyond a particular position.

4. The conveyor system of claim 3, further comprising:
a damper coupled to the second conveyor, the damper being configured to resist rotational movement of the second conveyor as the second conveyor rotates toward the hard stop.

5. The conveyor system of claim 4, wherein a spring force of the damper is less than a force of the second conveyor exerted as a result of the second downstream roller being biased toward the first conveyor.

6. The conveyor system of claim 1, wherein the second conveyor is located above the first conveyor.

7. The conveyor system of claim 6, wherein the second downstream roller is biased toward the first conveyor by gravity.

8. The conveyor system of claim 1, wherein the second downstream roller is biased toward the first conveyor by a biasing mechanism.

9. The conveyor system of claim 1, wherein at least one of the first and second conveyor belts includes a plurality of individual belt portions.

10. The conveyor system of claim 1, wherein at least one of the first and second conveyor belts includes at least one of an elastic material, an elastomeric material, or an anti-static material.

11. The conveyor system of claim 1, wherein the conveyor system is located downstream of a cutting mechanism configured to cut cushioning material into pieces, and wherein the first and second conveyors are configured to capture the pieces of the cushioning material cut by the cutting system.

12. The conveyor system of claim 1, wherein the driving mechanism is configured to rotate the first upstream roller and the second upstream roller in opposite rotational directions.

13. The conveyor system of claim 12, wherein the driving mechanism is coupled to the first and second upstream rollers via a timing belt.

14. The conveyor system of claim 13, wherein the timing belt is configured to engage a first gear fixedly coupled to the first upstream roller, a second gear fixedly coupled to the second upstream roller, and a third gear arranged to be driven by the driving mechanism.

15. A system for cutting and conveying cushioning material, the system comprising:
an infeed conveyor system configured to convey a supply of cushioning material;
a cutting mechanism configured to cut pieces of the cushioning material from the supply of cushioning material conveyed by the infeed conveyor system; and
a discharge conveyor system configured to capture the pieces of the cushioning material cut by the cutting mechanism and to discharge the pieces of the cushioning material, wherein the discharge conveyor system comprises:
a first conveyor in a fixed planar position,
a second conveyor configured to rotate about an upstream roller of the second conveyor, wherein a downstream roller of the second conveyor is biased toward the first conveyor, and
a driving mechanism configured to rotate at least one conveyor belt on one or more of the first conveyor or the second conveyor.

16. The system of claim 15, wherein the infeed conveyor system includes a third conveyor and a fourth conveyor, wherein the third conveyor is in a first fixed planar position that is co-planar with the first conveyor.

17. The system of claim 16, wherein the fourth conveyor is in a second fixed planar position that is substantially parallel to the third conveyor and is aligned with the upstream roller of the second conveyor.

18. The system of claim 15, wherein the cutting mechanism is located between the infeed conveyor system and the discharge conveyor system.

19. The system of claim 15, wherein the cushioning material includes one or more of pre-inflated bubble film inflated before arriving at a location of the system, bubble film inflated at the location of the system, or foam cushioning.

20. The system of claim 15, wherein the driving mechanism is configured to rotate the at least one conveyor belt at a rate that is equal to or greater than a rate at which a conveyor belt of the infeed conveyor system is rotated.
